(19) United States
(12) Patent Application Publication
(10) Pub. No.: US 2025/0173578 A1
(43) Pub. Date: May 29, 2025

(54) COMPUTATIONALLY EFFICIENT DISTILLATION USING GENERATIVE NEURAL NETWORKS

(71) Applicant: Google LLC, Mountain View, CA (US)

(72) Inventors: Ankit Singh Rawat, New York, NY (US); Manzil Zaheer, Mountain View, CA (US); Chong You, Jersey City, NJ (US); Seungyeon Kim, New York, NY (US); Andreas Veit, New York, NY (US); Himanshu Jain, Jersey City, NJ (US)

(21) Appl. No.: 18/839,584

(22) PCT Filed: Feb. 21, 2023
(86) PCT No.: PCT/US2023/013533

§ 371 Date: Aug. 19, 2024

Related U.S. Application Data
(60) Provisional application No. 63/311,911, filed on Feb. 18, 2022.

(51) Int. Cl. G06N 3/096; G06N 3/045

(52) U.S. Cl. CPC G06N 3/096; G06N 3/045

(57) ABSTRACT

Methods, systems, and apparatus for training a student neural network having multiple student parameters to perform a machine learning task. In one aspect, a system comprises one or more computers configured to obtain a batch comprising one or more training inputs to generate multiple modified training inputs. The one or more computers process each of the multiple modified training inputs using the student neural network and a teacher neural network to generate a respective student output and a respective teacher output for the machine learning task for each of the modified training inputs. The one or more computers update the student parameters by computing a gradient with respect to the student parameters of a loss function that includes a first term that measures, for each of the modified training inputs, a loss between the student output for the modified training input and the teacher output for the modified training input.

### CROSS-REFERENCE TO RELATED APPLICATIONS

This application claims the benefit of priority to U.S. Provisional Application Ser. No. 63/311,911, filed Feb. 18, 2022, the entirety of the prior application is incorporated herein by reference.

### BACKGROUND

This specification relates to training a neural network to perform a machine learning task.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a student neural network to perform a machine learning task.

In particular, to perform this training, the system makes use of a teacher neural network and a generative neural network. The teacher neural network is a neural network that is configured to perform the same machine learning task as the student, while the generative neural network is a neural network that includes an encoder neural network and a decoder neural network.

The encoder neural network is configured to receive an input that is of the same type as the inputs to the machine learning task and to process the input to generate a latent representation of the input. A “latent representation” is an ordered collection of numerical values, e.g., a vector, a matrix, or a higher-order tensor of floating point or other numerical values, in a pre-defined latent space, i.e., having a pre-defined dimensionality.

Generally, the dimensionality of the latent space is smaller than the space of possible inputs to the machine learning task. The decoder neural network is configured to receive an input latent representation and to process the input latent representation to generate an output that is of the same type as the inputs to the machine learning task.

According to a first aspect there is provided a method performed by one or more computers for training a student neural network. The student neural network has multiple student parameters to perform a machine learning task. The method comprises obtaining a batch comprising one or more training inputs and generating a plurality of modified training inputs, comprising, for each of the one or more training inputs, processing the training input using an encoder neural network to generate a latent representation of the training input, and generating one or more modified training inputs using the latent representation. Furthermore, generating each of the modified training inputs comprises generating, from the latent representation of the training input, a modified latent representation and processing the modified latent representation using a decoder neural network to generate the modified training input.

Additionally, the method comprises processing each of the plurality of modified training inputs using the student neural network to generate a respective student output for the machine learning task for each of the modified training inputs, processing each of the multiple modified training inputs using a teacher neural network to generate a respective teacher output for the machine learning task for each of the modified training inputs, where the teacher neural network has been pre-trained to perform the machine learning task, computing a gradient with respect to the student parameters of a loss function that includes a first term that measures, a loss between the student output for the modified training input and the teacher output for the modified training input for each of the modified training inputs, and updating the student parameters using the gradient.

Particular embodiments of the subject matter described in this specification can be implemented so as to realize one or more of the following advantages.

Very large neural networks trained on a large amount of training data have shown state-of-the-art performance on many machine learning tasks. However, these neural networks are not suitable for deployment within constrained memory spaces, i.e., on edge devices or in other computational environments where the amount of computational resource is limited. Thus, these neural networks cannot be used for on-device processing that is required for many edge applications.

Moreover, existing techniques that attempt to “distill” large models to compact models for efficient deployment generally require a large amount of (labeled or unlabeled) training data. However, for some tasks, such a large amount of training data may not be available. Even if such a large amount of training data is available, training the compact student model on such a large amount of training data may be prohibitively computationally expensive.

This implementation includes distillation techniques for training a computationally efficient student neural network by leveraging a teacher neural network and a generative neural network. Thus, by using the described techniques, a student neural network that can be deployed within a constrained memory space, i.e., on an edge device that has limited computational resources, can be trained to have performance that is comparable to or even exceeds that of a teacher neural network that performs the same task but that cannot be effectively deployed in the constrained memory space. It will be understood that deploying the student neural network within a memory space, e.g. a constrained memory space, may include storing the student neural network in the memory space (e.g. in the constrained memory space). It will also be understood that deploying the student neural network may include storing the student neural network in the memory of device(s) other than the device(s) on which the student neural network was trained.

Additionally, by incorporating an already trained generative neural network into the training of the student neural network, the described techniques obviate the need to go through a large volume of data. Thus, the described techniques can be especially effective for regimes where the amount of training data is limited, where the computational resources available for training the student neural network are limited, or in long-tail data regimes where the set of categories includes multiple long-tail categories that each have relatively few training inputs in the training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a teacher guided training system.

FIG. 2 is a block diagram of the operation of the teacher guided training system during training of the student neural network.

FIG. 3 is a flow diagram of an example process for training a student neural network to perform a machine learning task.

Like reference numbers and designations in the various drawings indicate like elements.

### DETAILED DESCRIPTION

This specification describes a system implemented as computer programs on one or more computers in one or more locations that trains a student neural network to perform a machine learning task.

Generally, the machine learning task that the student neural network is trained to perform can be appropriate classification task. As used in this specification, a classification task is any task that requires the neural network to generate an output that specifies one or more respective score distributions over a plurality of categories and to then select one or more highest scoring categories from each of the score distributions as a “classification” for the network input.

One example of a classification task is image classification, where the input to the neural network is an image, i.e., the intensity values of the pixels of the image, the categories are object categories, and the task is to classify the image as depicting an object from one or more of the object categories.

Another example of a classification task is image segmentation, where the input to the neural network is an image, i.e., the intensity values of the pixels of the image, the categories are object categories, and the task is to classify each pixel in the image as depicting an object from one or more object categories. For example, the object categories can include a “background object” category that includes the background of the scene and one or more categories corresponding to possible foreground objects.

Another example of a classification task is text classification, where the input to the neural network is text and the task is to classify the text as belonging to one of the categories. One example of such a task is a sentiment analysis task, where each category corresponds to different possible sentiments of the task. Another example of such a task is a reading comprehension task, where the input text includes a context passage and a question and the categories each correspond to different segments from the context passage that might be an answer to the question. Other examples of text processing tasks that can be framed as classification tasks include an entailment task, a paraphrase task, a textual similarity task, a sentiment task, a sentence completion task, a grammaticality task, and so on.

Another example of a classification task is machine translation, where the input to the neural network is text in one language and the task is to generate scores for text in a target language that represent the likelihood that the text in the target language is a translation of the input text.

Other examples of classification tasks include speech processing tasks, where the input to the neural network is audio data representing speech. Examples of speech processing tasks include speech recognition (where the categories are different possible transcriptions of the speech), language identification (where the categories are different possible languages for the speech), hotword identification (where the categories indicate whether one or more specific “hotwords” are spoken in the audio data), and so on.

Another example of a classification task is text-to-speech (where the classes are different possible utterances of the text).

As another example, the task can be a health prediction task, where the input is a sequence derived from electronic health record data for a patient and the categories are respective predictions that are relevant to the future health of the patient, e.g., a predicted treatment that should be prescribed to the patent, the likelihood that an adverse health event will occur to the patient, or a predicted diagnosis for the patient.

As another example, the task can be an agent control task, where the input is one or more observations or other data characterizing states of an environment, and the output defines score distributions over actions to be performed by the agent in response to the most recent observation. The agent can be, e.g., a real-world or simulated robot, a control system for an industrial facility, or a control system that controls a different kind of agent.

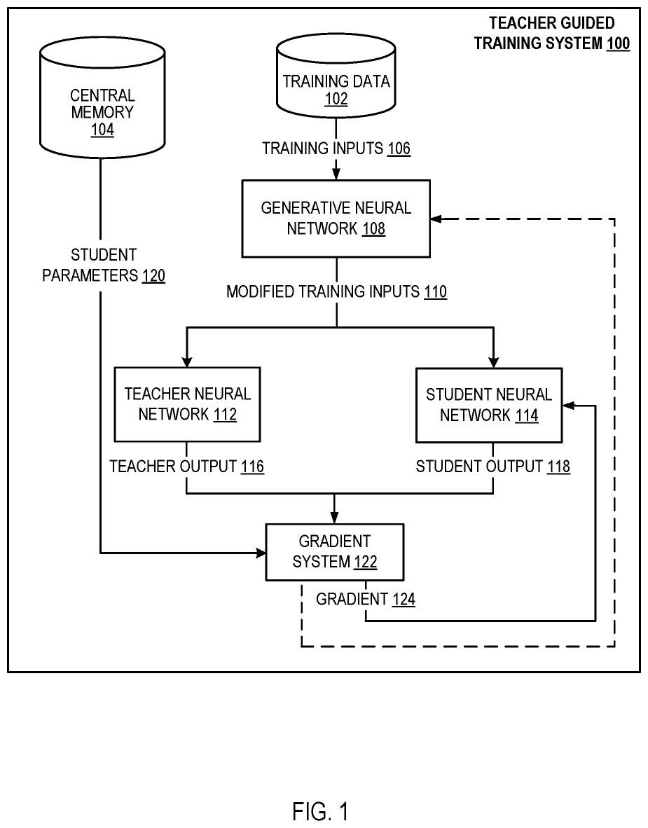

FIG. 1 shows a teacher guided training system 100. The system 100 (e.g., the teacher guided training system 100) is an example of a system implemented as computer programs one or more computers in one or more locations, in which the systems, components, and techniques described below can be implemented.

The system 100 trains a student neural network 114 to perform a machine learning task. The student neural network 114 is a neural network having parameters (“student parameters” 120). The student neural network 114 is configured to receive a network input and to process the network input in accordance with the student parameters 120 to generate a network output for the network input for the machine learning task. As described above, the machine learning task can be any of a variety of machine learning tasks.

For example, during training, the system 100 can store the student parameters 120 in a central memory 104.

The student neural network 114 can have any appropriate architecture that allows the neural network to perform the particular machine learning task, i.e., to map network inputs of the type and dimensions required by the task to network outputs of the type and dimensions required by the task.

As one example, when the inputs are images, the student neural network 114 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the student neural network 114 can be a recurrent neural network, e.g., a long short-term memory (LSTM) or gated recurrent unit (GRU) based neural network, a convolutional neural network, or a Transformer neural network.

As another example, the student neural network 114 can be feed-forward neural network, e.g., an MLP, that includes multiple fully-connected layers.

In particular, to perform the training of the student neural network 114, the system 100 makes use of a teacher neural network 112 and a generative neural network 108.

The student neural network 114 and the teacher neural network 112 are generally both neural networks that are configured to perform the same machine learning task. The teacher neural network 112 has been pre-trained to perform the machine learning task, e.g., has been trained on a set of training data 102 that will be used to train the student neural network 114 or on a different set of training to optimize an objective function for the machine learning task using conventional machine learning techniques.

In some cases, the student neural network 114 and the teacher neural network 112 have the same architecture and, therefore the same number of parameters. For example, both neural networks can be convolutional neural networks, self-attention-based neural networks (Transformers), or recurrent neural networks. In these cases, the system 100 trains the student neural network 114 to have improved performance relative to the teacher neural network 112 even though the two have the same architecture.

In some other cases, however, the two neural networks have different architectures, with the teacher neural network 112 having a larger number of parameters than the student neural network 114. In these cases, a larger, less computationally efficient teacher neural network 112 is used to improve the performance of a smaller, computationally efficient student neural network 114. For example, both neural networks can be convolutional neural networks, self-attention-based neural networks (Transformers), or recurrent neural networks, but with the student neural network 114 having fewer parameters because of having fewer layers, operating on internal representations that have smaller sizes (e.g., fewer output filters in the case of a convolutional layer or smaller dimensions of the queries, keys, and values for a self-attention sub-layer in a Transformer), or both.

In this case, after training, the student neural network 114 can be deployed on an edge computing device or, more generally, in a computing environment with limited computational budget where the teacher neural network 112 could not be effectively deployed, e.g., because the parameters of the teacher neural network 112 would not fit in the memory of the edge computing device or because the latency of the teacher neural network 112 would be too large when deployed on the edge computing device.

For example, the student neural network 114 can be deployed on a mobile device, or can be embedded within a robot or a vehicle. The student neural network 114 can generate new student outputs from new training inputs at the edge device.

The generative neural network 108 is a neural network that includes an encoder neural network and a decoder neural network. The encoder neural network is configured to receive an input that is of the same type as the inputs to the machine learning task and to process the input to generate a latent representation of the input.

A “latent representation” is an ordered collection of numerical values, e.g., a vector, a matrix, or a higher-order tensor of floating point or other numerical values, in a pre-defined latent space, i.e., having a pre-defined dimensionality. The decoder neural network is configured to receive an input latent representation and to process the input latent representation to generate an output that is of the same type as the inputs to the machine learning task.

The generative neural network 108 has been pre-trained on an objective that encourages the neural network to accurately reconstruct received inputs, i.e., such that, when the decoder neural network processes a latent representation of a given input that has been generated by the encoder neural network, the output generated by the decoder is an accurate reconstruction of the given input. Examples of such objectives include auto-encoding objectives, variational auto-encoding objectives, generative adversarial networks (GAN) objectives, and so on.

The neural network 108 is referred as a “generative” neural network 108 because, in addition to reconstructing existing inputs, the decoder neural network can be used to generate new training inputs when provided a new latent representation as input.

More specifically, the system 100 trains the student neural network 114 on a respective batch of training inputs 106 at each of multiple training steps. Each batch of training inputs 106 includes one or more training inputs, e.g., a fixed size number of training input samples from a larger batch of training data 102.

At any given training step, the system 100 uses the generative neural network 108 to generate modified training inputs 110 from the training inputs 106, and the system 100 uses the teacher neural network 112 and the student neural network 114 to generate a teacher output 116 and a student output 118, respectively, for each modified training input 110.

The system 100 uses a gradient system 122 to compute a gradient 124 with respect to the student parameters 120 of a loss function that measures errors between corresponding teacher outputs 116 and student outputs 118. In particular, by incorporating the modified training inputs 110 generated by the generative neural network 108 into the training, the system 100 makes the training of the student neural network more efficient, i.e., relative to training using only the training inputs 106. Optionally, the gradient system 122 can adjust the modified training inputs 110 using gradients of the loss function.

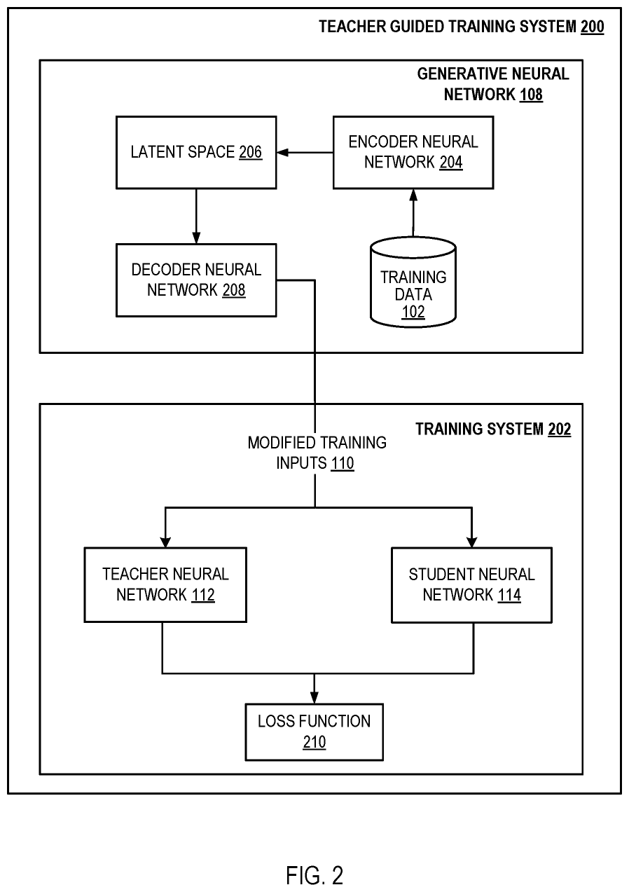

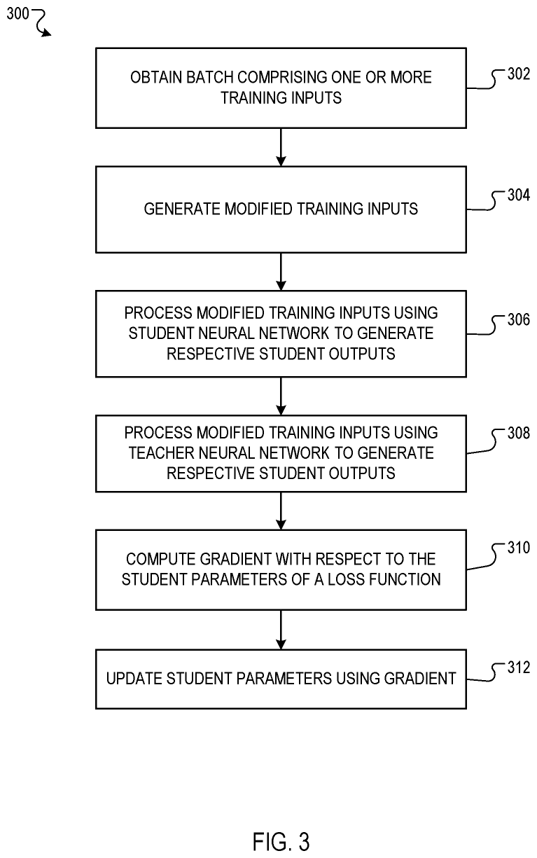

The training of the student neural network 114 will be described in more detail below with reference to FIGS. 2 and 3.

FIG. 2 shows a teacher guided training system 200 during training of the student neural network. The teacher guided training system 200 (e.g., the teacher guided training system 200 during training of the student neural network) is an example of a system in which the systems, components, and techniques described below are implemented. For convenience, the system 200 will be described as being implemented by a system of one or more computers located in one or more locations. For example, a system, e.g., the system 100 of FIG. 1, appropriately programmed in accordance with this specification, can implement the system 200.

The system 200 includes a generative neural network 108 and a training system 202. The system 200 is configured to use the generative neural network 108 to generate modified training inputs 110 to train the student neural network 114 of the training system 202.

The generative neural network 108 includes an encoder neural network 204 and a decoder neural network 208. The generative neural network 108 obtains a batch of training data 102. The batch of training data 102 includes one or more training inputs.

The training system 202 includes the teacher neural network 112 and the student neural network 114 . . . . The training system 202 processes the modified training inputs 110 using the teacher neural network 112 and the student neural network 114. The teacher neural network 112 generates one or more teacher outputs, and the student neural network 114 generates one or more student outputs. The training system 202 uses the outputs of the teacher neural network 112 and the student neural network 114 to compute a gradient of a loss function 210. The training system 202 uses the gradient of the loss function 210 to update the student parameters of the student neural network using the modified training inputs 214.

The generative neural network 108 is a neural network that has been pre-trained on an objective (e.g., a machine learning task) that encourages the generative neural network 108 to accurately reconstruct received inputs. Examples of such objectives include auto-encoding objectives, variational auto-encoding objectives, generative adversarial networks (GAN) objectives, and so on.

The encoder neural network 204 and the decoder neural network 208 have been trained jointly on an objective that includes one or more terms that encourage reconstructions of received inputs to be similar to the corresponding received inputs. Each reconstruction is generated by processing the received input using the encoder neural network 204 to generate a latent representation of the received input and processing the latent representation of the received input using the decoder neural network 208 to generate the reconstruction of the received input.

The encoder neural network 204 is configured to receive an input that is of the same type as the inputs to the machine learning task and to process the input to generate a latent representation of the input. A “latent representation” is an ordered collection of numerical values, e.g., a vector, a matrix, or a higher-order tensor of floating point or other numerical values, in a pre-defined latent space, i.e., having a pre-defined dimensionality (e.g., latent space 206). Generally, the dimensionality of the latent space 206 is smaller than the space of possible inputs to the machine learning task.

The decoder neural network 208 is configured to receive an input latent representation and to process the input latent representation to generate an output that is of the same type as the inputs to the machine learning task. The generative neural network 108 is referred to as a “generative” neural network because, in addition to reconstructing existing inputs, the decoder neural network 208 of the generative neural network 108 can be used to generate new training inputs when provided a new latent representation as input.

In conventional implementations, such as knowledge distillation, a system distills a teacher neural network to a compact model for efficient deployment by incorporating the teacher neural network (e.g., a teacher labeler system) to train the student neural network.

However, distilling the teacher neural network for use in training the student neural network requires a large amount of training data that may not be available for some tasks. Additionally, training the student neural network on such a large amount of training data can be computationally expensive.

To account for this, the system 200 is configured to distill knowledge to the student neural network 114 by leveraging a latent representation of the training inputs from the batch of training data 102. The encoder neural network 204 maps each training input of the batch of training data 102 to a latent representation in the latent space 206. The encoder neural network 204 processes the latent representation to generate a modified latent representation. The encoder neural network 204 can generate the modified latent representation from the latent representation by performing random perturbation or gradient ascent, as described in more detail below with reference to FIG. 3. The decoder neural network 208 transforms the modified latent representation back to the original data space of the batch of training data 102 to generate one or more modified training inputs 110.

For each of the one or more training inputs of the batch of training data 102, the generative neural network 103 processes the training inputs using the encoder neural network 204. The encoder neural network 204 generates a respective latent representation of the training inputs (e.g., latent training inputs), and the encoder neural network 204 processes the respective latent representation to generate a respective modified latent representation.

As described above, the dimensionality of the latent space 206 is smaller than the space of possible inputs to the machine learning task. Thus, by modeling the training inputs in the latent space 206 to generate the modified latent representation, the system 200 reduces the complexity of the batch of training data 102 by generating modified training inputs 110 from the modified representation, which can lead to more efficiently training the student neural network 114 on the machine learning task.

The decoder neural network 208 of the generative neural network 108 generates new training inputs (e.g., the modified training inputs 110) from the modified latent. In some implementations, the generative neural network 108 generates a single modified training input 110 for each of the one or more training inputs. In some other implementations, the generative neural network 108 generates multiple modified training inputs 110 for each of the one or more training inputs.

The training system 202 then uses the modified training inputs 110 to train the student neural network 114.

The training system 202 processes the modified training inputs 110 and the original training inputs using the teacher neural network 112 and the student neural network 114 to train the student neural network 114.

In particular, the student neural network 114 generates a respective student output from each of the modified training inputs 110 and, optionally, the original training inputs. The teacher neural network 112 generates a respective teacher output from each of the modified training inputs 110 and, optionally, the original training inputs.

The training system 202 uses the loss function 210 to update the student parameters of the student neural network 114.

The loss function 210 measures a difference (e.g., a loss) between, for each modified training input 110, the student output generated for the training inputs and the teacher output generated for the training input. In some examples, the loss function 210 can include a cross-entropy loss, a KL divergence, or any other appropriate measure of the difference between two score distributions (e.g., the student output and the teacher output).

In addition to one or more terms that measure the difference between student and teacher outputs for modified training inputs, the loss function 210 can optionally have one or more other terms. One example of a loss function is shown below in the loss function of Equation 1:

$${R}_{f}^{TGT} ( {S}_{n}^{lαbeled} ) := \frac{1}{m} {\sum }_{j ∈ [ m ]} {l}_{d} ( f ( {\tilde{x}}_{j} ) , h ( {\tilde{x}}_{j} ) ) + \frac{1}{n} {\sum }_{i ∈ [ n ]} {l}_{d} ( f ( {x}_{i} ) , h ( {x}_{i} ) ) + \frac{1}{n} {\sum }_{i ∈ [ n ]} l ( f ( {x}_{i} ) , {y}_{i} ) ) \qquad ( 1 )$$

In this example, f represents the student neural network 114 and h represents the teacher neural network 112 and, the loss function R_{f}^{TGT} operates on Sₙ^{labeled}, a labeled data set of training inputs and corresponding target outputs from the batch of training data 102, m represents the number of modified training inputs, and n represents the number of labeled training inputs from the labeled data set of training inputs.

The first term

$$( \frac{1}{m} {\sum }_{j ∈ [ m ]} {l}_{d} ( f ( {\tilde{x}}_{j} ) h ( {\tilde{x}}_{j} ) )$$

of the loss function 220 measures, for each of the modified training inputs 214 (\tilde{x}), a loss l_{d} between the student output for the modified training input f(\tilde{x}ⱼ) and the teacher output for the modified training input h(\tilde{x}ⱼ). For example, the loss l_{d} can be a cross-entropy loss or K-L divergence loss between the student output f(\tilde{x}ⱼ) and the teacher output h(\tilde{x}ⱼ). The system 200 can leverage the information of the first term to update the modified training inputs 110 and to generate updated modified training inputs, as described in more detail below with reference to FIG. 3.

In some examples, the loss function 210 includes the second term

$$\frac{1}{n} {\sum }_{i ∈ [ n ]} {l}_{d} ( f ( {x}_{i} ) , h ( {x}_{i} ) ) .$$

The second term measures, for each training input of the original training inputs (xᵢ), a loss between the student output for the original training input f(xᵢ) and the teacher output for the original training input (h(xᵢ)).

The second term represents the conventional distillation technique, where the teacher neural network 112 provides supervision for the student neural network 114.

Additionally, in some examples, the loss function 210 includes the third term

$$\frac{1}{n} {\sum }_{i ∈ [ n ]} l ( f ( {x}_{i} ) , {y}_{i} ) )$$

where l is the loss function, ƒ(xᵢ) is the student output for the original training input, and y is a target output (e.g., the ground truth label) for the original training input. The third term uses the ground truth labels of the Sₙ^{labeled} labeled data set to calculate the loss between the student output of the original training inputs and the target output of the labeled data set.

Thus, the third term measures a difference between the student output for the original training input and the target output for the original training input. The target output is a ground truth that is the output that should be generated by performing the machine learning task on the training input and that is obtained from the batch of training data 102 for the machine learning task.

In some cases, some or all of the original training inputs for a given training step may not have an associated target output and, in these cases, the training system 202 does not use these “unlabeled” training inputs when computing a gradient of the third term.

To train the student neural network, the training system 202 computes a gradient for the one or more terms with respect to the student parameters of the student neural network 114. The training system 202 uses the gradient to update and refine the student parameters of the student neural network 114.

That is, the system 200 applies an appropriate optimizer, e.g., Adam, Adafactor, stochastic gradient descent, a learned optimizer, or another appropriate optimizer, to the gradient to generate an update and then applies the update to the current student parameters of the student neural network 114. For example, the system 200 can apply the update by adding or subtracting the update from the values of the current student parameters.

FIG. 3 is a flow diagram of an example process 300 for training a student neural network to perform a machine learning task. For convenience, the process 300 will be described as being performed by a system of one or more computers located in one or more locations. For example, a system, e.g., the system 100 of FIG. 1, appropriately programmed in accordance with this specification, can perform the process 300.

The system can repeatedly perform iterations of the process 300 to repeatedly update the parameters of the student neural network until a termination criterion has been satisfied, e.g., until a threshold number of iterations of the process 300 have been performed, until a threshold amount of wall clock time has elapsed, or until the values of the network parameters have converged.

The system obtains a batch of training data comprising one or more training inputs (302).

The system can generate multiple modified training inputs from the batch of training data (304). The system generates the multiple modified training inputs using the generative neural network.

In particular, the system generates multiple modified training inputs by processing each training input of the one or more training inputs using the encoder neural network of the generative neural network.

For each training input, the encoder neural network generates a latent representation of the training input by projecting the training inputs onto the latent space.

The encoder neural network then generates one or more modified latent representations from the latent representation.

The system processes the one or more modified latent representations using the decoder neural network of the generative neural network to generate one or more modified training inputs for training the student neural network.

In some examples, the encoder neural network can generate each modified latent representation by performing random perturbation. In these examples, the encoder neural network uses noise to randomly initialize the modified latent representation of the training inputs.

Specifically, the encoder neural network samples noise from a noise distribution (e.g., a Gaussian distribution), and the encoder neural network applies the sampled noise to the latent representation to generate the modified latent representation.

Thus, the random perturbation is a zero-order (e.g., isotopic) process, which is represented by Equation 3:

$$\tilde{x} = Dec ( Enc ( ( x ) + v ) \qquad ( 3 )$$

where Dec represents the decoder neural network, Enc represents the encoder neural network 306, and v is the sampled noise described above. The encoder neural network randomly applies a different value of noise v to each latent representation of the training inputs. The encoder neural network can apply the noise to the latent representation in the latent space to generate the modified latent representation, and the decoder neural network can generate the modified training inputs from the modified latent representation. When the system generates multiple different modified training inputs from a single training input, the system can generate multiple different modified latent representations from the single latent representation from the single training input by sampling different noise from the noise distribution.

Alternatively, the system can generate multiple modified latent representations for each training input by performing gradient ascent (e.g., backpropagation) on the latent representation of the training input. The system performs backpropagation by “searching” for informative candidate instances of training inputs included in the batch of training data using the gradient of the first term of the loss function described above in FIG. 2.

The system leverages the loss function to determine instances (e.g., training inputs) for which the student output differs from the teacher output. As such, the system can update the modified latent representation at each of multiple gradient ascent steps to include instances where the classification of the student neural network will most likely differ from the teacher neural network, which can increase the effectiveness of training.

The training inputs where the two neural networks (e.g., the student neural network and the teacher labeler system) maximally-differ are represented by the argmax function of Equation 4:

$$\tilde{x} = {argmax}_{x ∈ n}^{l ( h ( x ) , f ( x ) )} \qquad ( 4 )$$

The system can use the argmax function of Equation 4 to determine the training inputs for which the corresponding outputs of the neural networks most differ.

The system can search for candidate instances of the latent representation in the latent space.

The system can run multiple iterations (e.g., steps) of gradient ascent on Equation 4 to search for a training input corresponding to the student output that diverges most with the teacher output.

At each gradient ascent step, the system processes a current modified latent representation to generate an updated modified training input using the decoder neural network.

The system then processes the updated modified training input using the student neural network and the teacher neural network to generate a student output and a teacher output, respectively, of the updated modified training input.

The system can use the student output and the teacher output to compute a gradient with respect to the current modified latent representation of a loss between the student output and the teacher output. For example, the system can compute the gradient by backpropagating gradients of the loss through the student neural network and into the decoder neural network. The system can update the current modified latent representation using the gradient, e.g., by applying learning rate to the gradient and then adding or subtracting the resulting product from the current modified latent representation or using a different type of machine learning update rule.

At the first gradient ascent step, he current modified latent representation is the latent representation of the training input. Subsequently, for each gradient ascent step after the first gradient ascent step, current modified latent representation is the updated modified latent representation after the preceding gradient ascent step.

After the last gradient ascent step, the encoder neural network sets the modified latent representation to be the latest updated current modified latent representation. The system can then use the decoder neural network to generate the updated modified training input from the updated modified latent representation.

The system processes each of the multiple modified training inputs and, optionally, the original training inputs using the student neural network to generate a respective student output for each of the multiple training inputs to perform the machine learning task (306).

The system processes each of the multiple modified training inputs and, optionally, the original training inputs using the teacher neural network to generate a respective teacher output for each of the multiple training inputs to perform the machine learning task (308).

Using the generated student outputs and the teacher outputs, the system computes the gradient with respect to the student parameters of a loss function (310). The loss function includes a first term that measures a loss between the respective student output and the respective teacher output for each of the multiple modified training inputs. In some examples, the loss function includes a second term that measures a loss between the student output for the original training input and the teacher output for the original training input.

In some examples, the system can obtain a respective target output for each training input. In this case, the loss function can include a third term that measures a loss between the student output for the training input and the target output for the training input.

The system then updates the student parameters using the gradient of the loss function (412). The system applies an appropriate optimizer, e.g., Adam, Adafactor, stochastic gradient descent, a learned optimizer, or another appropriate optimizer, to the gradient to generate an update and then applies the update to the current student parameters of the student neural network.

In some examples, the system updates the current modified latent representation using the gradient of the first term of the loss function.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a student neural network having a plurality of student parameters to perform a machine learning task, the method comprising:
obtaining a batch comprising one or more training inputs;
generating a plurality of modified training inputs, comprising, for each of the one or more training inputs:
processing the training input using an encoder neural network to generate a latent representation of the training input, and
generating one or more modified training inputs using the latent representation, wherein generating each of the modified training inputs comprises:
generating, from the latent representation of the training input, a modified latent representation; and
processing the modified latent representation using a decoder neural network to generate the modified training input;
processing each of the plurality of modified training inputs using the student neural network to generate a respective student output for the machine learning task for each of the modified training inputs;
processing each of the plurality of modified training inputs using a teacher neural network to generate a respective teacher output for the machine learning task for each of the modified training inputs, wherein the teacher neural network has been pre-trained to perform the machine learning task;
computing a gradient with respect to the student parameters of a loss function that includes a first term that measures, for each of the modified training inputs, a loss between (i) the student output for the modified training input and (ii) the teacher output for the modified training input; and
updating the student parameters using the gradient.

2. The method of claim 1, further comprising:
processing each of the one or more training inputs using the student neural network to generate a respective student output for the machine learning task for each of the one or more training inputs; and
processing each of the one or more training inputs using the teacher neural network to generate a respective teacher output for the machine learning task for each of the one or more training inputs,
wherein the loss function includes a second term that measures, for each training input, a loss between (i) the student output for the training input and (ii) the teacher output for the training input.

3. The method of claim 1, further comprising:
obtaining a respective target output for each training input, wherein the loss function includes a third term that measures, for each training input, a loss between (i) the student output for the training input and (ii) the target output for the training input.

4. The method of claim 1, wherein generating, from the latent representation of the training input, a modified latent representation comprises:
sampling noise from a noise distribution; and
generating the modified latent representation by applying the sampled noise to the latent representation of the training input.

5. The method of claim 1, wherein generating, from the latent representation of the training input, a modified latent representation comprises:
performing a sequence of one or more gradient ascent steps, wherein performing each gradient ascent step comprises:
processing the current modified latent representation using the decoder neural network to generate an updated modified training input;
processing the updated modified training input using the student neural network to generate a student output for the machine learning task for the updated modified training input;
processing the updated modified training input using the teacher neural network to generate a teacher output for the machine learning task for the updated modified training input;
computing a gradient with respect to the current modified latent representation of a loss between the student output for the updated modified training input and the teacher output for the updated modified training input; and
updating the current modified latent representation using the gradient.

6. The method of claim 5, wherein:
for a first gradient ascent step, the current modified latent representation is the latent representation of the training input,
for each gradient ascent step after the first gradient ascent step, the current modified latent representation is the updated modified latent representation after a preceding gradient ascent step, and
the modified latent representation is the updated modified latent representation after the last gradient ascent step.

7. The method of claim 6, wherein computing a gradient with respect to the current modified latent representation of a loss between the student output for the updated modified training input and the teacher output for the updated modified training input comprises:
backpropagating gradients through the student neural network.

8. The method of claim 1, wherein the encoder neural network and the decoder neural network have been trained jointly on an objective that includes one or more terms that encourage reconstructions of received inputs to be similar to the corresponding received inputs, wherein each reconstruction is generated by processing the received input using the encoder neural network to generate a latent representation of the received input and processing the latent representation of the received input using the decoder neural network to generate the reconstruction of the received input.

9. The method of claim 1, further comprising:
after training the student neural network, deploying the student neural network on an edge device for generating new output for new inputs received at the edge device.

10. The method of claim 9, wherein the edge device is a mobile device.

11. The method of claim 9, wherein the edge device is embedded within a robot or a vehicle.

12. The method of claim 1, wherein the student neural network has fewer parameters than the teacher neural network.

13. (canceled)

14. (canceled)

15. A system comprising one or more computers and one or more storage devices storing instructions that are operable, when executed by the one or more computers, to cause the one or more computers to perform operations for training a student neural network having a plurality of student parameters to perform a machine learning task, the operations comprising:
obtaining a batch comprising one or more training inputs;
generating a plurality of modified training inputs, comprising, for each of the one or more training inputs:
processing the training input using an encoder neural network to generate a latent representation of the training input, and
generating one or more modified training inputs using the latent representation, wherein generating each of the modified training inputs comprises:
generating, from the latent representation of the training input, a modified latent representation; and
processing the modified latent representation using a decoder neural network to generate the modified training input;
processing each of the plurality of modified training inputs using the student neural network to generate a respective student output for the machine learning task for each of the modified training inputs;
processing each of the plurality of modified training inputs using a teacher neural network to generate a respective teacher output for the machine learning task for each of the modified training inputs, wherein the teacher neural network has been pre-trained to perform the machine learning task;
computing a gradient with respect to the student parameters of a loss function that includes a first term that measures, for each of the modified training inputs, a loss between (i) the student output for the modified training input and (ii) the teacher output for the modified training input; and
updating the student parameters using the gradient.

16. The system of claim 15, further comprising:
processing each of the one or more training inputs using the student neural network to generate a respective student output for the machine learning task for each of the one or more training inputs; and
processing each of the one or more training inputs using the teacher neural network to generate a respective teacher output for the machine learning task for each of the one or more training inputs,
wherein the loss function includes a second term that measures, for each training input, a loss between (i) the student output for the training input and (ii) the teacher output for the training input.

17. The system of claim 15, further comprising:
obtaining a respective target output for each training input, wherein the loss function includes a third term that measures, for each training input, a loss between (i) the student output for the training input and (ii) the target output for the training input.

18. The system of claim 15, wherein generating, from the latent representation of the training input, a modified latent representation comprises:
sampling noise from a noise distribution; and
generating the modified latent representation by applying the sampled noise to the latent representation of the training input.

19. One or more computer-readable storage media storing instructions that when executed by one or more computers cause the one or more computers to perform operations for training a student neural network having a plurality of student parameters to perform a machine learning task, the operations comprising:
obtaining a batch comprising one or more training inputs;
generating a plurality of modified training inputs, comprising, for each of the one or more training inputs:
processing the training input using an encoder neural network to generate a latent representation of the training input, and
generating one or more modified training inputs using the latent representation, wherein generating each of the modified training inputs comprises:
generating, from the latent representation of the training input, a modified latent representation; and
processing the modified latent representation using a decoder neural network to generate the modified training input;
processing each of the plurality of modified training inputs using the student neural network to generate a respective student output for the machine learning task for each of the modified training inputs;
processing each of the plurality of modified training inputs using a teacher neural network to generate a respective teacher output for the machine learning task for each of the modified training inputs, wherein the teacher neural network has been pre-trained to perform the machine learning task;
computing a gradient with respect to the student parameters of a loss function that includes a first term that measures, for each of the modified training inputs, a loss between (i) the student output for the modified training input and (ii) the teacher output for the modified training input; and
updating the student parameters using the gradient.

20. The non-transitory computer storage media of claim 19, further comprising:
processing each of the one or more training inputs using the student neural network to generate a respective student output for the machine learning task for each of the one or more training inputs; and
processing each of the one or more training inputs using the teacher neural network to generate a respective teacher output for the machine learning task for each of the one or more training inputs,
wherein the loss function includes a second term that measures, for each training input, a loss between (i) the student output for the training input and (ii) the teacher output for the training input.

21. The non-transitory computer storage media of claim 19, further comprising:
obtaining a respective target output for each training input, wherein the loss function includes a third term that measures, for each training input, a loss between (i) the student output for the training input and (ii) the target output for the training input.

22. The non-transitory computer storage media of claim 19, wherein generating, from the latent representation of the training input, a modified latent representation comprises:
sampling noise from a noise distribution; and
generating the modified latent representation by applying the sampled noise to the latent representation of the training input.
